(19) United States
(12) Patent Application Publication
(10) Pub. No.: US 2023/0408735 A1
(43) Pub. Date: Dec. 21, 2023

(54) LENS ASSEMBLY

(71) Applicants: Dae Soon LIM, Yongin-si, Gyeonggi-do (KR); MICRO ACTUATOR CO., LTD., Gyeonggi-do (KR)

(72) Inventors: Dae Soon LIM, Yongin-si (KR); Hak Ku YOON, Suwon-si (KR); Myung Won CHOI, Yongin-si (KR)

(21) Appl. No.: 18/030,486

(22) PCT Filed: Oct. 19, 2021
(86) PCT No.: PCT/KR2021/014614

§ 371 Date: Apr. 5, 2023

(30) Foreign Application Priority Data
Nov. 2, 2020 (KR) 10-2020-0144193
May 7, 2021 (KR) 10-2021-0059123

(51) Int. Cl. G02B 3/00; G02B 7/00; G02B 13/00; G02B 7/02

(52) U.S. Cl. CPC G02B 3/0075; G02B 3/0068; G02B 7/005; G02B 13/001; G02B 7/023

(57) ABSTRACT

Disclosed is a lens assembly applied to a small mobile device. The lens assembly includes: a base; a support inserted into the base to be moved in an optical-axis direction; a lens module coupled to the support and disposed in the base; first and second optical image stabilization drive units each configured to move the lens module in a direction perpendicular to an optical-axis direction; and a plurality of hinge members configured to support the lens module to be moved with respect to the support, wherein each of the plurality of hinge members has one end connected to a coupling groove of the lens module and the other end connected to a coupling groove of the support, and the coupling groove of the lens module and the coupling groove of the support are open in the same direction as each other.

### TECHNICAL FIELD

Apparatuses and methods consistent with the disclosure relate to a lens assembly, and more particularly, to a compact lens assembly having auto focus and optical image stabilization functions.

### BACKGROUND ART

A lens assembly applied to a small mobile device such as a smartphone has a smaller size in accordance with technological development, and has auto focus (AF) and optical image stabilization (OIS) functions to obtain a high-quality captured image.

The auto focus function is a function of automatically focusing on a specific subject by moving a lens module included in the lens assembly forward or backward.

The optical image stabilization function is a function of detecting trembling of a mobile device (e.g., smartphone or tablet personal computer (PC)) by using a gyro sensor and finely moving the lens module in a direction opposite to a movement direction of the mobile device to correct the focus. A movement direction of the lens module during the optical image stabilization may be perpendicular to the movement direction of the lens during the auto focus. In the lens assembly, a number of elastic metal wires may support the lens module for the lens module to be smoothly moved during the optical image stabilization.

Recently, 108 million-pixel image sensors are applied to the small mobile device to implement the high-quality image, thus also increasing a size of the applied lens. Therefore, an amount of power consumed to drive a heavier lens module may be increased as the small mobile device adopts such a high-quality image sensor. As a result, the more camera function is used, the more often a battery embedded in the small mobile device has to be charged.

In addition, as a weight of the lens is increased, the thin metal wire cannot overcome a weight of the lens module, a central portion of the metal wire may thus be bent. Accordingly, the lens module may tilt and fail to accurately maintain the lens focus. Moreover, the small mobile device may not perform its function due to low impact resistance, such as the metal wire being easily broken in case of having an external impact applied thereto or being dropped on a floor.

A thicker metal wire than before may be used to solve this problem. However, in this case, a movement width of the lens module during the optical image stabilization may become smaller compared to the case of using the conventional thin wire. Therefore, more power may be required to be applied to an optical image stabilization drive unit for a normal operation of the small mobile device. This configuration may accelerate power consumption of the rechargeable battery in the small mobile device.

### DISCLOSURE

### Technical Problem

The disclosure provides a lens assembly in which a plurality of hinge members supporting the lens module to be moved for optical image stabilization are strong against an external impact and are not bent by a weight of the lens.

The disclosure also provides a lens assembly having an assembly structure allowing a compact hinge member to be easily connected to a lens module and a support.

### Technical Solution

According to one or more embodiments of the disclosure, a lens assembly includes: a base; a support inserted into the base to be moved in an optical-axis direction; a lens module coupled to the support and disposed in the base; first and second optical image stabilization drive units each configured to move the lens module in a direction perpendicular to an optical-axis direction; and a plurality of hinge members configured to support the lens module to be moved with respect to the support, wherein each of the plurality of hinge members has one end connected to a coupling groove of the lens module and the other end connected to a coupling groove of the support, and the coupling groove of the lens module and the coupling groove of the support are open in the same direction as each other.

The support may have one side in which first and second insertion grooves, into which the hinge members are respectively inserted, are formed at a distance from each other, and the other side which is opposite to the one side and in which third and fourth insertion grooves, into which the other hinge members are respectively inserted, are formed at a distance from each other.

The first to fourth insertion grooves may be open to the outside of the support.

The first and second insertion grooves may be open in the same direction as each other, and the third and fourth insertion grooves may be open in the same direction as each other.

The first and second insertion grooves and the third and fourth insertion grooves may be open in opposite directions to each other.

The lens assembly may further include an inner cover detachably coupled to the support, wherein the inner cover has first to fourth coupling parts respectively covering open sides of the first to fourth insertion grooves.

Each of the plurality of hinge members may have a pillar part disposed between the one end and the other end, a first hinge part formed between the one end and the pillar part, and a second hinge part formed between the other end and the pillar part, and the pillar part gradually may protrude convexly towards its center.

Each of first and second hinge parts may have a thickness smaller than that of the pillar part.

The plurality of hinge members may be injection-molded using synthetic resin having elasticity.

An adhesive may be applied to a portion where the one end of each of the plurality of hinge members and the lens module are connected to each other, and an adhesive may be applied to a portion where the other end of each of the plurality of hinge members and the support are coupled to each other.

A damping member may be formed in each of the first to fourth insertion grooves to surround each inserted hinge member. The damping member may be maintained in a gel state.

The lens assembly may further include an auto focus drive unit configured to move the support in the optical-axis direction.

The lens assembly may further include an outer cover covering one side of the base and having a light passage hole through which a portion of the lens module passes, wherein the inner cover is coupled with a plurality of bumper members each having elasticity to absorb an impact upon collision with the outer cover in case of being moved in the optical-axis direction.

Each of the plurality of bumper members may be snap-coupled to a coupling hole formed adjacent to each corner of the inner cover.

Each of the plurality of bumper members may include a first part protruding outward from the inner cover, and having a buffer groove formed in its side facing the outer cover; and a second part protruding inward from the inner cover.

The support may have an accommodating groove into which each second part of the plurality of bumper members is inserted.

### DESCRIPTION OF DRAWINGS

FIG. 1 is a view showing a lens assembly according to one or more embodiments of the disclosure.

FIG. 2 is an exploded perspective view showing the lens assembly according to one or more embodiments of the disclosure.

FIG. 3 is a perspective view showing a base shown in FIG. 2.

FIG. 4 is a perspective view showing an example in which a lens module and a support, shown in FIG. 2, are coupled to each other, and a lens unit is omitted from the lens module.

FIG. 5 is a perspective view showing an example in which the lens module and the support, shown in FIG. 2, are coupled to each other.

FIG. 6 is a cross-sectional view taken along line A-A indicated in FIG. 5.

FIG. 7 is a perspective view showing an example in which the lens module and the support are coupled to each other by an inner cover.

FIG. 8 is a perspective view showing an example in which a plurality of bumper members are coupled to the inner cover.

FIG. 9 is a plan view showing a state where the inner cover to which the plurality of bumper members are coupled and an outer cover coupled to the support.

FIG. 10 is a cross-sectional view taken along line B-B indicated in FIG. 9.

FIG. 11A is a perspective view showing another example of the lens unit and the lens module.

FIGS. 11B and 11C are views showing a process of coupling the lens unit to the lens module.

FIG. 12 is a cross-sectional view showing another example of an upper coupling part of the lens module to which the hinge member is coupled and a lower coupling part of the support.

### BEST MODE FOR INVENTION

Hereinafter, various embodiments are described in more detail with reference to the accompanying drawings. Embodiments described in the specification may be variously modified. A specific embodiment may be shown in the drawings and described in detail in a detailed description. However, the specific embodiment shown in the accompanying drawings is provided only to allow various embodiments to be easily understood. Therefore, it should be understood that the spirit of the disclosure is not limited by the specific embodiment shown in the accompanying drawings, and includes all the equivalents and substitutions included in the spirit and scope of the disclosure.

Terms including ordinal numbers such as “first” and “second,” may be used to describe various components. However, these components are not limited by these terms. The terms are used only to distinguish one component from another component.

In describing the disclosure, summarized or omitted is a detailed description of a case where it is decided that the detailed description for the known functions or configurations related to the disclosure may unnecessarily obscure the gist of the disclosure.

A lens assembly according to one or more embodiments of the disclosure may be manufactured to have a compact size, and installed in a small mobile device such as a smartphone to be used to capture an image.

Hereinafter, the lens assembly according to one or more embodiments of the disclosure is described with reference to the drawings.

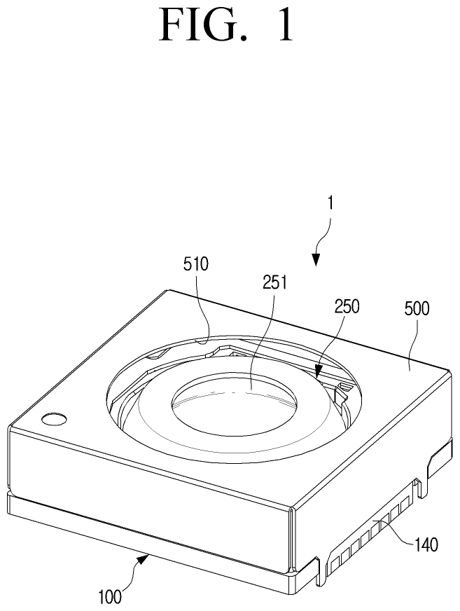

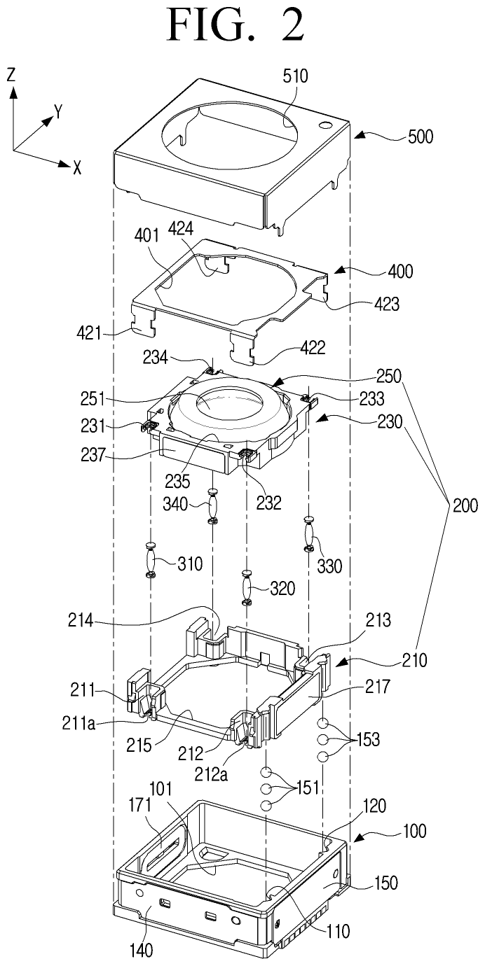

FIG. 1 is a view showing a lens assembly according to one or more embodiments of the disclosure; and FIG. 2 is an exploded perspective view showing the lens assembly according to one or more embodiments of the disclosure.

Referring to FIGS. 1 and 2, a lens assembly 1 according to one or more embodiments of the disclosure may include a base 100, a moving unit 200 moved to perform auto focus and optical image stabilization functions, and an outer cover 500 covering one side of the base 100.

The moving unit 200 may include a support 210 moved in an optical-axis direction (or Z-axis direction) together with a lens module 230 for the auto focus, the lens module 230 disposed in the support 210 for the optical image stabilization and moved in a direction perpendicular to an optical axis, a plurality of hinge members 310, 320, 330, and 340 each connecting the support 210 with the lens module 230 for the lens module 230 to be moved with respect to the support 210 in the direction perpendicular to the optical axis, an inner cover 400 maintaining the support 210 and the lens module 230 to be in a coupled state, an auto focus drive unit moving the support 210 forward or backward along the optical axis, and an optical image stabilization drive unit moving the lens module 230 in the direction perpendicular to the optical axis.

Referring to FIG. 2, the base 100 may be installed on a portion of a small mobile device (not shown), and a printed circuit board (not shown) on which an image sensor (not shown) is mounted may be disposed on a lower side of the base 100 (i.e., a side of the base 100 that is opposite to its side covered by the outer cover 500). In this case, the image sensor may be disposed at a position where its central portion corresponds to the optical axis.

The base 100 may have a substantially rectangular parallelepiped shape as shown in FIG. 2, is not limited thereto, and may be appropriately changed based on the size and shape of the small mobile device in which the lens assembly 1 is installed.

The base 100 may have a predetermined space where its upper side is open and the support 210 disposed therein is moved in the optical-axis direction. The base 100 may have a first light passage hole 101 formed at its bottom. Light passing through a lens 251 may be irradiated to the image sensor that is disposed on the lower side of the base 100 through the first light passage hole 101.

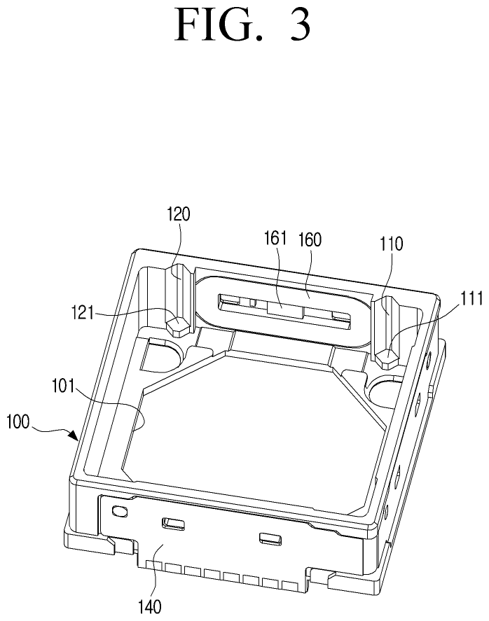

FIG. 3 is a perspective view showing the base shown in FIG. 2.

Referring to FIG. 3, the base 100 may have a pair of first guide grooves 110 and 120 disposed in one of inner surfaces of the base 100 at a predetermined distance and parallel to the optical-axis direction.

A plurality of ball bearings 151 and 153 may respectively slide in the pair of first guide grooves 110 and 120. The pair of first guide grooves 110 and 120 may have one side open (i.e., open upper side of the base 100), and the other side in which separation prevention ribs 111 and 121 are formed to prevent separation of the plurality of ball bearings 151 and 153 from the pair of first guide grooves 110 and 120.

The pair of first guide grooves 110 and 120 may respectively correspond to a pair of second guide grooves 216 and 218 formed in the support 210 in a state where the support 210 is inserted into the base 100.

Some ball bearings 151 among the plurality of ball bearings 151 and 153 may slide in the first guide groove 110 and the second guide groove 216, and the other ball bearings 153 may slide in the other first guide groove 120 and the second guide groove 218. Accordingly, the plurality of ball bearings 151 and 153 may slidably support the support 210 to be moved forward or backward along the optical axis.

The support 210 may be disposed inside the base 100 and coupled with the lens module 230. The support 210 may be inserted inside the base 100 for the lens module 230 to be moved forward or backward in the optical-axis direction.

The support 210 may have a second light passage hole 215 formed therein. In case that the support 210 is inserted into an inner space of the base 100, the second light passage hole 215 may corresponds to the first light passage hole 101 of the base 100. Light passing through the lens 251 may sequentially pass through the second light passage hole 215 and the first light passage hole 101 to reach the image sensor (not shown).

The support 210 may have first to fourth insertion grooves 211, 212, 213, and 214 into which the plurality of hinge members 310, 320, 330, and 340 are respectively inserted on one side and the opposite side thereof. For example, the first and second insertion grooves 211 and 212 may be disposed in one side of the support 210 at a predetermined distance, and the third and fourth insertion grooves 213 and 214 may be disposed in the other side of the support 210, opposite to the side where the first and second insertion grooves 211 and 212 are disposed, at the predetermined distance. In this case, the first insertion groove 211 may correspond to the fourth insertion groove 214, and the second insertion groove 212 may correspond to the third insertion groove 213.

Open sides of the first to fourth insertion grooves 211, 212, 213, and 214 may be disposed in a Y-axis direction. For example, the first and second insertion grooves 211 and 212 may all be equally open in an −Y direction, and the open sides of the third and fourth insertion grooves 213 and 214 may all be equally disposed in a +Y direction.

First to fourth lower coupling grooves 211a, 212a, 213a, and 214a to which lower ends of the plurality of hinge members 310, 320, 330, and 340 are coupled may be formed in lower portions of the first to fourth insertion grooves 211, 212, 213, and 214. Open sides of the first to fourth lower coupling grooves 211a, 212a, 213a, and 214a may respectively be formed in the same direction as that of the open sides of the first to fourth insertion grooves 211, 212, 213, and 214.

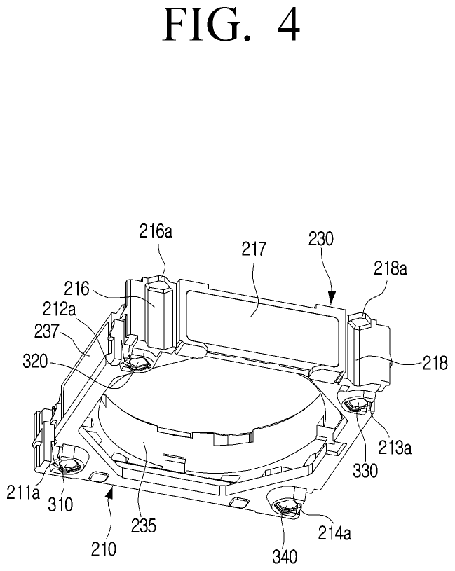

The direction of the open sides of the first to fourth insertion grooves 211, 212, 213, and 214 and the first to fourth lower coupling grooves 211a, 212a, 213a, and 214a (see FIG. 4) may consider the direction in which the insertion grooves are coupled to the plurality of hinge members 310, 320, 330, and 340 in a case where the support 210 and the lens module 230 are connected with each other, and a description thereof is provided below.

FIG. 4 is a perspective view showing an example in which the lens module and the support are coupled to each other, and the lens unit is omitted from the lens module.

Referring to FIG. 4, the support 210 may have the pair of second guide grooves 216 and 218 corresponding to the pair of first guide grooves 110 and 120. The pair of second guide grooves 216 and 218 may have one side open (i.e., open lower side of the support 210), and the other side in which separation prevention ribs 216a and 218a are formed to prevent separation of the plurality of ball bearings 151 and 153 from the pair of second guide grooves 216 and 218.

In case that the support 210 is inserted into the base 100, the pair of first guide grooves 110 and 120 and the pair of second guide grooves 216 and 218 may correspond to each other for the plurality of ball bearings 151 and 153 to be embedded therein. The plurality of ball bearings 151 and 153 may guide the support 210 to slide with respect to the base 100 between the pair of first guide grooves 110 and 120 and the pair of second guide grooves 216 and 218.

Meanwhile, a yoke plate 150 having an attractive force with a third magnet 237 may be disposed on an outer surface of the base 100, which is one side of a first coil 160. As the attractive force is generated between the yoke plate 150 and the third magnet 237, the support 210 may be pulled toward the yoke plate 150. Accordingly, the plurality of ball bearings 151 and 153 may be in close contact with the inner surfaces of the pair of first guide grooves 110 and 120 and the pair of second guide grooves 216 and 218 without a gap to prevent movement of the support 210 in a direction perpendicular to the optical-axis direction in case that the support 210 is moved in the optical-axis direction.

A lens unit 250 including the lens 251 may be coupled to a through hole 235 formed in an approximate center of the lens module 230. In this way, the lens module 230 may be coupled to and integrated with the lens unit 250, and moved together with the lens unit in a direction perpendicular to the optical axis during the optical image stabilization.

Referring to FIG. 4, the lens module 230 may have one side in which first and second upper coupling grooves 231 and 232 are formed at a predetermined distance and the other side which is opposite to one side of the lens module 230 and in which third and fourth upper coupling grooves 233 and 234 are formed at the predetermined distance.

Open sides of the first and second upper coupling grooves 231 and 232 may be disposed in the −Y axis direction which is the same direction as that of the first and second lower coupling grooves 211a and 212a. Open sides of the third and fourth upper coupling grooves 233 and 234 may be disposed in the +Y axis direction which is the same direction as that of the third and fourth lower coupling grooves 213a and 214a.

In case that the lens module 230 is inserted into the support 210, the first upper coupling groove 231 and the first lower coupling groove 211a may correspond to each other in the Z-axis direction. Similarly, the second to fourth upper coupling grooves 232, 233, and 234 may respectively correspond to the second to fourth lower coupling grooves 212a, 213a, and 214a in the Z-axis direction.

Accordingly, in case that the lens module 230 is inserted into the support 210, the open sides of the first upper coupling groove 231 and the first lower coupling groove 211a may be disposed in the same direction as each other, and one hinge member 310 may be used to connect the support 210 and the lens module 230 to each other in one step. Similarly, the open sides of the second to fourth upper coupling grooves 232, 233, and 234 and the second to fourth lower coupling grooves 212a, 213a, and 214a may respectively disposed in the same direction as each other, and the three hinge members 320, 330 and 340 may be used to connect the support 210 and the lens module 230 to each other in one step.

Under such a hinge connection structure, in case of assembling the compact lens assembly 1 according to the disclosure, the parts (e.g., support and lens module) may be easily connected to each other by using the hinge member, thereby reducing assembly time and improving productivity.

The description sequentially describes the auto focus drive unit and the optical image stabilization drive unit with reference to FIGS. 2 to 4.

The auto focus drive unit may include the first coil 160 (see FIG. 3) disposed on the inner surface of the base 100 and a first magnet 217 disposed on the outer surface of the support 210.

The first coil 160 may be disposed between the pair of first guide grooves 110 and 120 and electrically connected to a printed circuit board 140. In this case, the printed circuit board 140 may be disposed along outer three surfaces of the base 100 for the first coil 160 and a second coil 171 and a third coil (not shown), described below, to be electrically connected thereto.

The first magnet 217 may be disposed between the pair of second guide grooves 216 and 218.

In case that the support 210 is inserted into the base 100, the first coil 160 and the first magnet 217 may face each other at a predetermined distance. Under this disposition, in case that a current is applied to the first coil 160 in a forward or backward direction, the support 210 may be moved in the optical-axis direction (i.e., +Z-axis direction or −Z axis direction) through an interaction between the first coil 160 and the first magnet 217. Accordingly, in case that the lens module 230 is moved forward or backward together with the support 210 in the optical-axis direction, the auto focus may be controlled while adjusting a distance between the lens 251 and the image sensor.

A first hall sensor 161 may be mounted on the printed circuit board 140. The first hall sensor may be disposed inside the first coil 160 having a closed curve shape to detect movement of the first magnet 217 and transmit a detected signal to a controller of the small mobile device. The controller may perform control of the lens module 230 in the optical-axis direction (or Z-axis direction) through the first hall sensor and the auto focus drive unit. In the disclosure, a driving integrated circuit (IC) including the first hall sensor may be used instead of the first hall sensor 161.

The optical image stabilization drive unit may include a first optical image stabilization drive unit moving the lens module 230 in an X-axis direction and a second optical image stabilization drive unit moving the lens module 230 in the Y-axis direction.

The first optical image stabilization drive unit may include the second coil 171 disposed on one of four side surfaces of the base 100 and a second magnet (not shown) disposed on one of four side surfaces of the lens module 230. The second magnet may be disposed on a surface opposite to the surface on which the first magnet 217 is disposed in a state where the lens module 230 is disposed inside the support 210.

The second magnet may face the second coil 171 at the predetermined distance in case that the lens module 230 is disposed inside the base 100 together with the support 210.

The first optical image stabilization drive unit may move the lens module 230 in the +X-axis direction or −X-axis direction through its interaction with the second magnet based on a direction in which the current is applied to the second coil 171.

The second coil 171 may be electrically connected to the printed circuit board 140 installed on the base 100.

A second hall sensor (not shown) may be mounted on the printed circuit board 140. The second hall sensor may be disposed inside the second coil 171 having the closed curve shape to detect movement of the second magnet and transmit a detected signal to the controller of the small mobile device. The controller may perform control of the lens module 230 in the X-axis direction through the second hall sensor and the first optical image stabilization drive unit. In the disclosure, a driving IC including the second hall sensor may be used instead of the second hall sensor.

The second optical image stabilization drive unit may include the third coil (not shown) disposed on a side surface of the four side surfaces of the base 100 that is adjacent to the side surface on which the second coil 171 is disposed, and the third magnet 237 disposed on a side surface of the four sides of the lens module 230 that is adjacent to the side surface on which the second magnet is disposed.

The third magnet 237 may face the third coil at the predetermined distance in case that the lens module 230 and the support 210 are disposed in the inner space of the base 100.

The second optical image stabilization drive unit may move the lens module 230 in the +Y axis direction or −Y axis direction through its interaction with the third magnet 237 based on a direction in which the current is applied to the third coil.

The third coil may be electrically connected to the printed circuit board 140 installed on the base 100.

A third hall sensor (not shown) may be mounted on the printed circuit board 140. The third hall sensor may be disposed inside the third coil having the closed curve shape to detect movement of the third magnet 237 and transmit a detected signal to the controller of the small mobile device. The controller may perform control of the lens module 230 in the Y-axis direction through the third hall sensor and the second optical image stabilization drive unit. In the disclosure, a driving IC including the third hall sensor may be used instead of the third hall sensor.

As described above, the lens module 230 may be moved in the X-axis direction by the first optical image stabilization drive unit and moved in the Y-axis direction by the second optical image stabilization drive unit. Accordingly, the first and second optical image stabilization drive units may move the lens module 230 in the X-axis direction and the Y-axis direction to correct the disposition of the lens 251 caused by a user's hand trembling.

Therefore, the lens module 230 may be movably connected to the support 210 by the plurality of hinge members 310, 320, 330, and 340 to be described below, and moved to any position on an X-Y plane while being supported by the support 210.

Hereinafter, the description describes the plurality of hinge members 310, 320, 330, and 340 that support the lens module 230 to be moved in the direction perpendicular to the optical-axis direction (or X-axis or Y-axis direction).

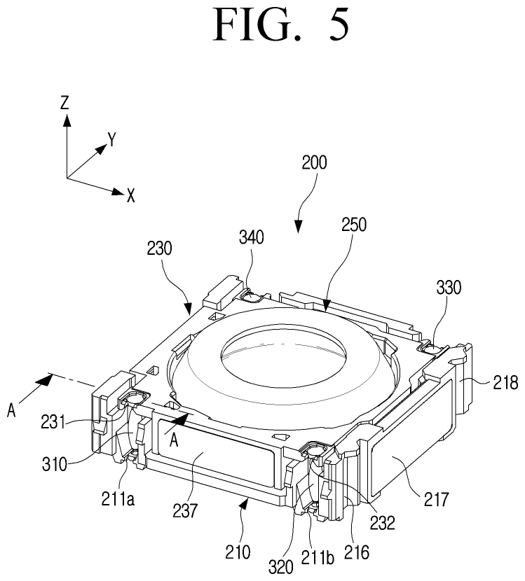

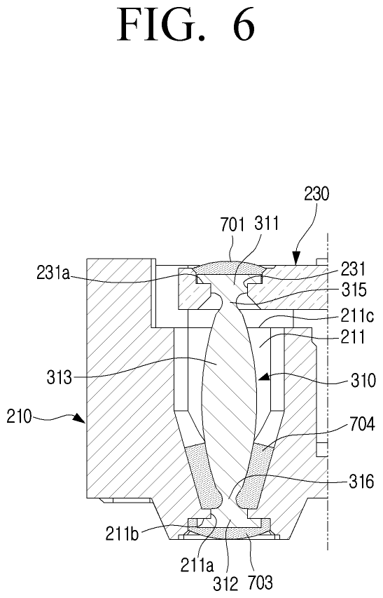

FIG. 5 is a perspective view showing an example in which the lens module and the support, shown in FIG. 2, are coupled to each other; and FIG. 6 is a cross-sectional view taken along line A-A indicated in FIG. 5.

Referring to FIG. 5, the plurality of hinge members 310, 320, 330, and 340 may have their lower ends respectively inserted and fixed to the first to fourth lower coupling grooves 211a, 212a, 213a, and 214a of the support 210, and their upper ends respectively inserted and fixed to the first to fourth upper coupling grooves 231, 232, 233, and 234 of the lens module 230.

The plurality of hinge members 310, 320, 330, and 340 may each be made of a material having elasticity to return to its original position in case that the first or second optical image stabilization drive unit is not operated after moved to a point on the X-Y plane by the first or second optical image stabilization drive unit.

In detail, the plurality of hinge members 310, 320, 330, and 340 may each be injection-molded using synthetic resin that is non-conductive and has excellent durability. A material of the plurality of hinge members 310, 320, 330, and 340 may be the synthetic resin having elasticity, for example, thermoplastic elastomer (TPE).

The plurality of hinge members 310, 320, 330, and 340 may be made of the synthetic resin material and thus may be manufactured by injection-molding. In a conventional lens assembly having a very thin wire made of a conventional metal material, the wire may be easily broken in case that the external impact was applied thereto. However, the hinge member according to this embodiment may be resistant to the external impact applied to the lens assembly 1, thus improving reliability of its product due to its excellent durability.

The plurality of hinge members 310, 320, 330, and 340 may all have the same shape, and the description below describes in detail a structure in which one hinge member 310 connects the support 210 and the lens module 230 to each other.

Referring to FIG. 6, the hinge member 310 may include an upper end 311, a lower end 312, a pillar part 313 disposed between the upper end and the lower end and having predetermined length and thickness, a first hinge part 315 formed between the upper end 311 and the pillar part 313, and a second hinge part 316 formed between the lower end 312 and the pillar part 313.

The upper end 311 of the hinge member may be inserted and fixed to the first upper coupling groove 231. In this case, the upper end 311 of the hinge member may have a shape corresponding to that of a step 231a formed in the first upper coupling groove 231, thus improving a coupling strength between the upper end 311 of the hinge member and the first upper coupling groove 231.

In addition, the upper end 311 of the hinge member may be compressed and inserted into the first upper coupling groove 231. In this case, the upper end 311 of the hinge member may be firmly coupled to the first upper coupling groove 231 by elasticity of the hinge member.

Meanwhile, a damping member 704 may fill the first insertion groove 211 into which the hinge member 310 is inserted. The damping member 704 may be injected into the first insertion groove 211 while the hinge member 310 is inserted into the first insertion groove 211.

The damping member 704 may surround at least a portion of the pillar part 313 of the hinge member in a state of being injected into the first insertion groove 211. The damping member 704 may be a damping bond, and maintained in a substantially gel state even after its curing is completed after application. The damping member 704 may serve as a damper that absorbs the external impact applied to the lens assembly 1 or an impact occurring during a control process.

Referring to FIG. 6, the damping member 704 may be formed in the first insertion groove 211 to an extent of supporting the pillar part 313 of the hinge member by about ⅓. Alternatively, the damping member 704 may fill up to the upper end 211c of the first insertion groove 211. In this case, the damping member 704 may surround almost the entire pillar part 313 of the hinge member. In this way, an amount of the damping member 704 filling the first insertion groove 211 may be appropriately adjusted based on a required damping strength.

The damping member 704 may remain in a gel state without being completely cured after the application, thus absorb the external impact applied to the lens assembly 1, and may not interfere with an hinge operation of the second hinge part 316. In addition, the damping member 704 may prevent the hinge member 310 from excessively vibrated during optical image stabilization (OIS) control.

A coupling structure between the lower end 312 of the hinge member and the first lower coupling groove 211a may be the same as or similar to the above-described coupling structure between the upper end 311 of the hinge member and the first upper coupling groove 231.

For example, the lower end 312 of the hinge member may be inserted and fixed to the first lower coupling groove 211a. In this case, the lower end 312 of the hinge member may have a shape corresponding to that of a step 211b formed in the first lower coupling groove 211a, thus improving a coupling strength between the lower end 312 of the hinge member and the first lower coupling groove 211a.

In addition, the lower end 312 of the hinge member may be compressed and inserted into the first lower coupling groove 211a. In this case, the lower end 312 of the hinge member may be firmly coupled to the first lower coupling groove 211a by elasticity of the hinge member.

In this embodiment, in case that the lens module 230 is inserted into the support 210, the first upper coupling groove 231 into which the upper end 311 of the hinge member is inserted and the first lower coupling groove 211a into which the lower end 312 of the hinge member is inserted may be open in the same direction as each other. Accordingly, while the hinge member 310 is inserted into the first insertion groove 211, the upper end 311 and the lower end 312 of the hinge member may be simultaneously or sequentially coupled thereto. In this way, the hinge member 310 may connect the support 210 and the lens module 230 to each other in one step. Accordingly, compared to a conventional process of assembling the hinge member to the support and the lens module through two or more steps, assembling processes may be minimized and an assembly speed may also be greatly improved, thus increasing production efficiency.

The hinge member 310 may connect the support 210 and the lens module 230 to each other in one step. Here, adhesives 701 and 703 may be applied to a connection portion between the hinge member 310 and the support 210 and a connection portion between the hinge member 310 and the lens module 230. In case that the adhesives 701 and 703 are cured, a connection state between the hinge member 310 and the support 210 and a connection state between the hinge member 310 and the lens module 230 may respectively be stronger.

The pillar part 313 may have a thickness gradually increased from an upper end (or a portion adjacent to the first hinge part 315) and lower end (or a portion adjacent to the second hinge part 316) thereof toward its center, and the center of the pillar part 313 may thus entirely have a convex shape. In this case, a vertical cross section of the pillar part 313 may be substantially elliptical, and its transverse cross section may be substantially circular.

A Lens applied to the small mobile device tends to have a larger size for high-resolution capturing. As the lens has the larger size in this way, a weight of the lens may also be heavier. In case that a weight of the lens module 230 is heavy, a conventional wire hinge using the metal material may be bent due to its ductility, making it difficult to control the position of the lens module 230. However, in this embodiment, the pillar part 313 may use the convex hinge member 310 to thus increase the rigidity of the hinge member 310, and the hinge member 310 may support the lens module 230 without being bent even in case that the weight of the lens module 230 is heavier.

Each of the first and second hinge parts 315 and 316 may have a thickness smaller than that of the pillar part 313. Accordingly, a portion between the upper end 311 and the pillar part 313, and a portion between the lower end 312 and the pillar part 313 may each be bent at a predetermined angle in any direction of 360 degrees.

In case that the first and second optical image stabilization drive units are operated, the first and second hinge parts 315 and 316 may be bent at the predetermined angle, and the lens module 230 may thus be smoothly moved along the X-axis and the Y-axis. In addition, the first and second hinge parts 315 and 316 may return to their original shapes by elasticity in case that power of the first and second optical image stabilization drive units is cut off.

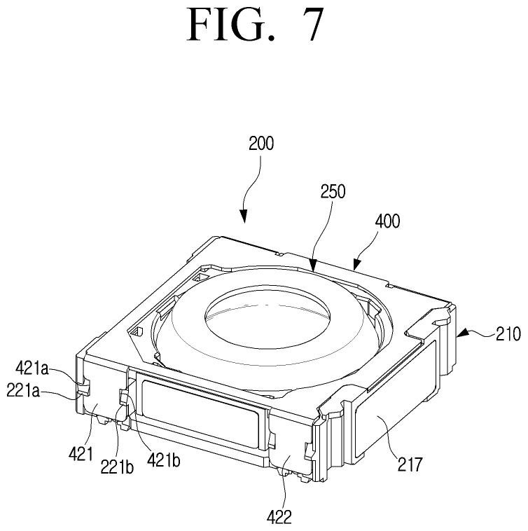

FIG. 7 is a perspective view showing an example in which the lens module and the support are coupled to each other by the inner cover.

Referring to FIG. 7, the inner cover 400 may prevent the lens module 230 inserted into the support 210 from being separated from the support 210. The inner cover 400 may have a third light passage hole 401 (see FIG. 2) through which an upper portion of the lens unit 250 may be exposed.

The inner cover 400 may be detachably coupled to the support 210 to cover a portion of an opening of the support 210 for inserting the lens module 230 into the support 210.

The inner cover 400 may include first to fourth coupling parts 421, 422, 423, and 424 that are bent and respectively corresponding to the first to fourth insertion grooves 211, 212, 213, and 214 of the support 210.

The first to fourth coupling parts 421, 422, 423, and 424 may be coupled to the support 210 while covering the open sides of the first to fourth insertion grooves 211, 212, 213, and 214. Accordingly, the first to fourth coupling parts 421, 422, 423, and 424 may protect the plurality of hinge members 310, 320, 330, and 340, respectively disposed in the first to fourth insertion grooves 211, 212, 213, and 214.

The first to fourth coupling parts 421, 422, 423, and 424 may all have the same shape, and the description below describes only the first coupling part 421.

The first coupling part 421 may have a pair of snap coupling grooves 421a and 421b to which a pair of protrusions 221a and 221b formed on both sides of the first insertion groove 211 are detachably snap-coupled. Similarly, the second to fourth coupling parts 422, 423, and 424 may each have a pair of snap coupling grooves respectively snap-coupled to a pair of protrusions respectively formed in the second to fourth insertion grooves 212, 213, and 214 corresponding thereto.

Referring to FIG. 2, the outer cover 500 may be coupled to the base 100 and cover the inner cover 400. The outer cover 500 may also have a fourth light passage hole 510 through which the upper portion of the lens unit 250 may be exposed. The outer cover 500 may be made of a metal material which may shield an electromagnetic wave.

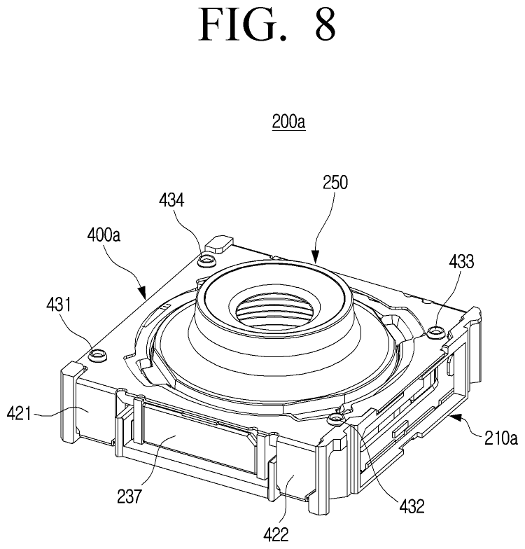

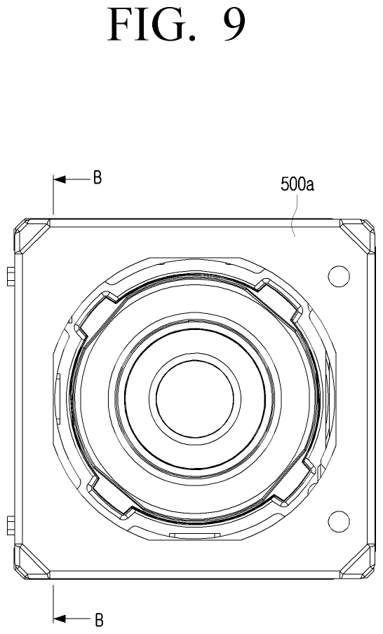

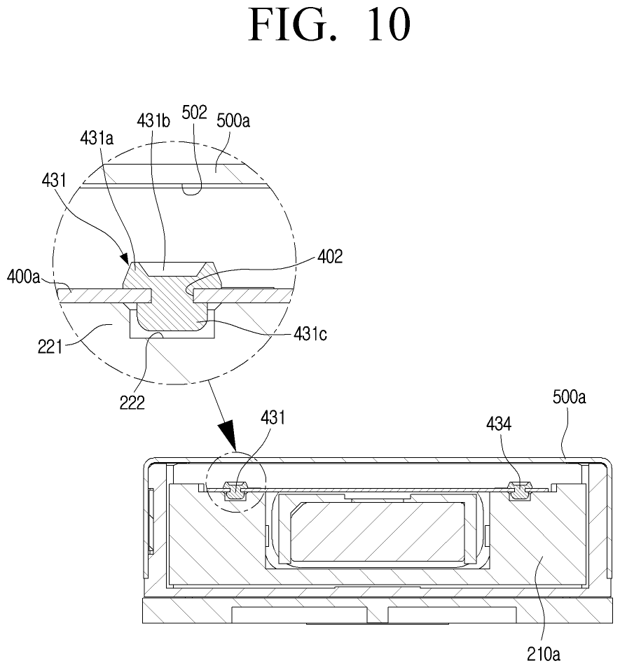

FIG. 8 is a perspective view showing an example in which a plurality of bumper members are coupled to an inner cover; FIG. 9 is a plan view showing a state where the inner cover to which the plurality of bumper members are coupled and an outer cover coupled to a support; and FIG. 10 is a cross-sectional view taken along line B-B indicated in FIG. 9.

Referring to FIGS. 8 and 9, a plurality of bumper members 431, 432, 433, and 434 may be coupled to an upper surface of an inner cover 400a.

Each of the plurality of bumper members 431, 432, 433, and 434 may be coupled adjacent to each corner of the inner cover 400a having a substantially quadrangular shape. Accordingly, in case that the inner cover 400a is coupled to a support 210a, each of the plurality of bumper members 431, 432, 433, and 434 may be adjacent to each corner of the support 210a.

The plurality of bumper members 431, 432, 433, and 434 may each be made of rubber or a synthetic resin material having elasticity. The plurality of bumper members 431, 432, 433, and 434 may prevent the inner cover 400a from colliding with an inner surface 502 of the outer cover 500a and simultaneously eliminate noise (or collision sound) fundamentally occurring during the collision in case that a moving unit 200a is moved forward in the optical-axis direction by the driving of the auto focus drive unit.

The plurality of bumper members 431, 432, 433, and 434 may all have the same shape, and the description below describes the shape of one bumper member 431 in detail.

Referring to FIG. 10, the bumper member 431 may be detachably snap-coupled to a coupling hole 402 formed in the inner cover 400a.

The bumper member 431 may have a first part 431a protruding outward from the inner cover 400a, and a buffer groove 431b for absorbing the impact that is formed in an upper surface of the first part 431a.

The bumper member 431 may have a second part 431c protruding inward from the inner cover 400a. In this case, the support 210a may have an accommodating groove 222 corresponding to the second part 431c of the bumper member 431.

As the second part 431c of the bumper member 431 is accommodated in the accommodating groove 222, it is possible to prevent the bumper member 431 from protruding forward from the support 210a by a length of the second part 431c in case that the inner cover 400a is coupled to the support 210a. It is thus possible to have an overall thickness of the moving unit 200a made as thin as possible, and secure a movement distance of the moving unit 200a between the support 210a and the outer cover 500a.

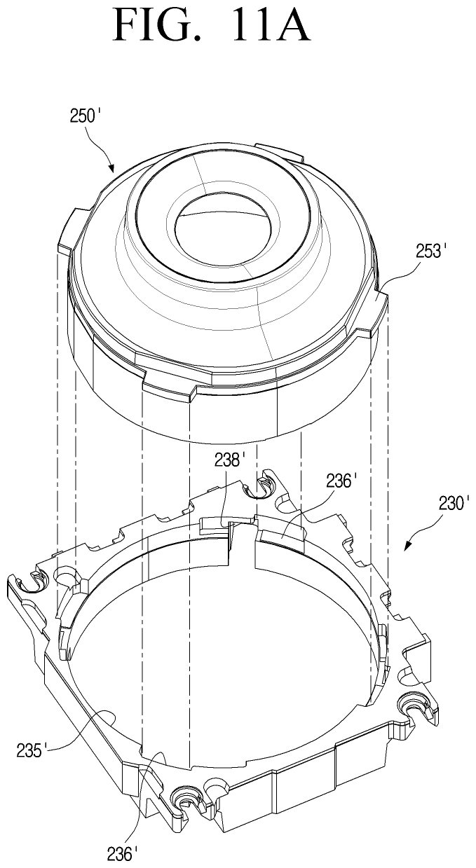

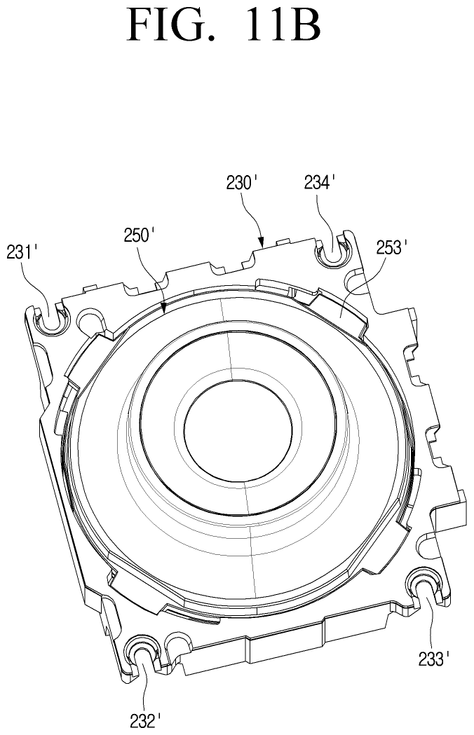

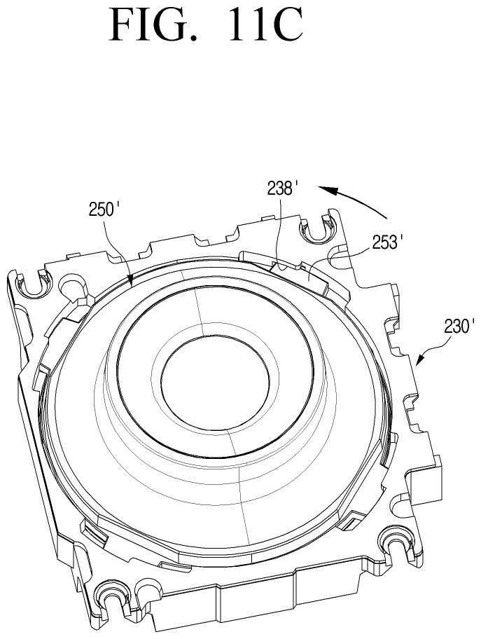

FIG. 11A is a perspective view showing another example of a lens unit and a lens module; and FIGS. 11B and 11C are views showing a process of coupling the lens unit to the lens module.

Referring to FIG. 11A, a lens unit 250′ may be detachably coupled to a lens module 230′.

To this end, a plurality of fastening ribs 253′ may protrude along an outer circumference of the lens unit 250′ at a predetermined distance from each other in a radial direction. In the disclosure, it is described that four fastening ribs 253′ are arranged at the same angle (e.g., 90 degrees) (see FIG. 11B), which is not limited thereto, and at least two fastening ribs may be sufficient.

The lens module 230′ may have a plurality of seating grooves 236″ formed along an inner circumference of a through hole 235″, into which the lens unit 250′ is inserted, while having a predetermined distance from each other. The number of the plurality of seating grooves 236″ may be the same as the number of the plurality of fastening ribs 253′ to respectively correspond to the plurality of fastening ribs 253′. The plurality of seating grooves 236″ may be formed in the optical-axis direction.

Each seating groove 236″ may be connected to a corresponding locking groove 238′. For example, in a state where the fastening ribs 253′ are inserted into the seating grooves 236″ as shown in FIG. 11B, some of the fastening ribs 253′ may be locked in case that the lens unit 250′ is rotated around the optical axis in a direction C as shown in FIG. 11C.

As such, according to the disclosure, the plurality of fastening ribs 253′ may be formed in the lens unit 250′, and the plurality of seating grooves 236″ and the locking grooves 238′ connected thereto may be formed in the lens module 230′. As a result, the lens unit 250′ may be detachably locked to the lens module 230′.

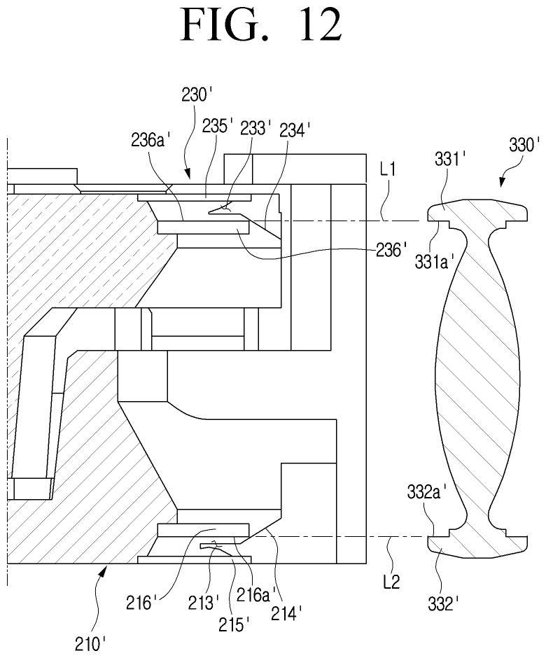

FIG. 12 is a cross-sectional view showing another example of an upper coupling part of the lens module to which a hinge member is coupled and a lower coupling part of the support.

Referring to FIG. 12, the lens module 230′ may have one side in which first and second upper coupling grooves 231′ and 232′ are formed at a predetermined distance and the other side which is opposite to one side of the lens module 230′ and in which third and fourth upper coupling grooves 233′ and 234′ are formed at the predetermined distance.

The support 210′ may include first to fourth lower coupling grooves respectively corresponding to the first to fourth upper coupling grooves 231′, 232′, 233′, and 234′ of the lens module 230′. FIG. 12 shows only the third lower coupling groove 213′ among the first to fourth lower coupling grooves.

Directions in which the first to fourth upper coupling grooves of the lens module 230′ and the first to fourth lower coupling grooves of the support 210′ are open are the same as the directions in which the first to fourth upper coupling grooves of the lens module 230 and the first to fourth coupling grooves of the support 210 are open, described above, and the description thus omits a detailed description thereof.

An upper end 331′ of a hinge member 330′ may be inserted into the third upper coupling groove 233′ of the lens module 230′, and a lower end 332′ of the hinge member 330′ may be inserted into the third lower coupling groove 213′ of the support 210′.

The third upper coupling groove 233′ of the lens module 230′ may be formed by a first part 235′ and a second part 236′ that corresponds to the first part 235′ at a distance therefrom.

The third lower coupling groove 213′ of the support 210′ may be formed by the first part 215′ and the second part 216′ that corresponds to the first part 215′ at a distance therefrom.

In this case, a distance between one surface 236a′ of the second part 236′ of the third upper coupling groove 233′ and one surface 216a′ of the second part 216′ of the third lower coupling groove 213′ may correspond to a distance between a lower surface 331a′ of the upper end 331′ of the hinge member 330′ and an upper surface 332a′ of the lower end 332′ of the hinge member 330′. Accordingly, the upper end 331′ and lower end 332′ of the hinge member 330′ may respectively be easily coupled to the third upper coupling groove 233′ and the third lower coupling groove 213′ along an imaginary first line L1 and an imaginary second line L2 without a separate interference structure.

Although the embodiments of the disclosure are shown and described hereinabove, the disclosure is not limited to the above mentioned specific embodiments, and may be variously modified by those skilled in the art to which the disclosure pertains without departing from the gist of the disclosure as disclosed in the accompanying claims. These modifications should also be understood to fall within the scope and spirit of the disclosure.

### INDUSTRIAL APPLICABILITY

The disclosure provides a compact lens assembly having auto focus and optical image stabilization functions.

What is claimed is:

1. A lens assembly comprising:
a base;
a support inserted into the base to be moved in an optical-axis direction;
a lens module coupled to the support and disposed in the base;
first and second optical image stabilization drive units each configured to move the lens module in a direction perpendicular to an optical-axis direction; and
a plurality of hinge members configured to support the lens module to be moved with respect to the support,
wherein each of the plurality of hinge members has one end connected to a coupling groove of the lens module and the other end connected to a coupling groove of the support, and
the coupling groove of the lens module and the coupling groove of the support are open in the same direction as each other.

2. The lens assembly as claimed in claim 1, wherein the support has
one side in which first and second insertion grooves, into which the hinge members are respectively inserted, are formed at a distance from each other, and
the other side which is opposite to the one side and in which third and fourth insertion grooves, into which the other hinge members are respectively inserted, are formed at a distance from each other.

3. The lens assembly as claimed in claim 2, wherein the first to fourth insertion grooves are open to the outside of the support.

4. The lens assembly as claimed in claim 3, wherein the first and second insertion grooves are open in the same direction as each other, and
the third and fourth insertion grooves are open in the same direction as each other.

5. The lens assembly as claimed in claim 3, wherein the first and second insertion grooves and the third and fourth insertion grooves are open in opposite directions to each other.

6. The lens assembly as claimed in claim 2, further comprising an inner cover detachably coupled to the support,
wherein the inner cover has first to fourth coupling parts respectively covering open sides of the first to fourth insertion grooves.

7. The lens assembly as claimed in claim 1, wherein each of the plurality of hinge members has
a pillar part disposed between the one end and the other end,
a first hinge part formed between the one end and the pillar part, and
a second hinge part formed between the other end and the pillar part, and
the pillar part gradually protrudes convexly towards its center.

8. The lens assembly as claimed in claim 7, wherein each of first and second hinge parts has a thickness smaller than that of the pillar part.

9. The lens assembly as claimed in claim 7, wherein the plurality of hinge members are injection-molded using synthetic resin having elasticity.

10. The lens assembly as claimed in claim 1, wherein an adhesive is applied to a portion where the one end of each of the plurality of hinge members and the lens module are connected to each other, and
an adhesive is applied to a portion where the other end of each of the plurality of hinge members and the support are coupled to each other.

11. The lens assembly as claimed in claim 2, wherein a damping member is formed in each of the first to fourth insertion grooves to surround each inserted hinge member.

12. The lens assembly as claimed in claim 11, wherein the damping member is maintained in a gel state.

13. The lens assembly as claimed in claim 1, further comprising an auto focus drive unit configured to move the support in the optical-axis direction.

14. The lens assembly as claimed in claim 6, further comprising an outer cover covering one side of the base and having a light passage hole through which a portion of the lens module passes,
wherein the inner cover is coupled with a plurality of bumper members each having elasticity to absorb an impact upon collision with the outer cover in case of being moved in the optical-axis direction.

15. The lens assembly as claimed in claim 14, wherein each of the plurality of bumper members is snap-coupled to a coupling hole formed adjacent to each corner of the inner cover.

16. The lens assembly as claimed in claim 14, wherein each of the plurality of bumper members includes
a first part protruding outward from the inner cover, and having a buffer groove formed in its side facing the outer cover; and
a second part protruding inward from the inner cover.

17. The lens assembly as claimed in claim 16, wherein the support has an accommodating groove into which each second part of the plurality of bumper members is inserted.
